(19) United States
(12) Patent Application Publication
(10) Pub. No.: US 2026/0152911 A1
(43) Pub. Date: Jun. 4, 2026

(54) CRAWLER VEHICLE

(71) Applicant: PRINOTH S.P.A., Vipiteno (IT)

(72) Inventors: Günther Steiner, Vipiteno (IT); Alberto Paoletti, Vipiteno (IT); Martin Kirchmair, Vipiteno (IT)

(21) Appl. No.: 19/394,368

(22) Filed: Nov. 19, 2025

(30) Foreign Application Priority Data
Nov. 29, 2024 (IT) 102024000027078

(51) Int. Cl. E01H 4/02; B60K 35/22

(52) U.S. Cl. CPC E01H 4/02; B60K 35/22; B60K 2360/135; B60K 2360/1438; B60K 2360/167; B60K 2360/176

(57) ABSTRACT

A crawler vehicle having a frame; a driver's cab mounted on the frame; a seat for a driver of the crawler vehicle arranged within the driver's cab; and a plurality of screens, each of which is arranged within the driver's cab and is configured to display a screenshot reproducing operational information. The crawler vehicle includes a control system configured to control the screenshot displayed by each screen; and a user interface. The user interface is configured to receive commands from the driver of the crawler vehicle and to transmit the commands to the control system, and is arranged at such a distance from the seat so as to be controllable by the driver of the crawler vehicle while the driver is seated on the seat.

### PRIORITY CLAIM

This application claims the benefit of and priority to Italian Patent Application No. 102024000027078, filed on Nov. 29, 2024, the entire contents of which is incorporated by reference herein.

### TECHNICAL FIELD

The present disclosure relates to a crawler vehicle, such as a crawler vehicle used for the preparation of ski runs.

### BACKGROUND

Crawler type vehicles are used to advance along off-road routes for the purpose of transporting goods and/or people and/or to carry out a wide range of different jobs, such as preparing the snowpack of ski runs or cleaning beaches, or for agricultural operations.

Typically, each crawler vehicle comprises a frame, a driver's cab mounted on the frame, and a pair of motorized tracks. In particular, the driver's cab is equipped with a seat for a driver and with a user interface, which is arranged near the seat, comprises a control device to allow the driver to control the crawler vehicle, and allows the display of crawler vehicle operational parameters, such as travel speed or remaining range of the crawler vehicle.

However, as the relative complexity of the working environment, the tasks to be performed and the crawler vehicle itself continues to increase, more and more information needs to be displayed in modern crawler vehicles and, as a result, currently known user interfaces are relatively inadequate for this purpose.

### SUMMARY

An aim of the present disclosure is to provide a crawler vehicle that mitigates certain of the drawbacks of certain of the prior art.

In accordance with certain embodiments of the present disclosure, a crawler vehicle is provided, such as a crawler vehicle for preparing ski runs. The crawler vehicle is configured to advance in a travelling direction and comprising a frame, a driver's cab, which is mounted on the frame and comprises a windscreen, a seat for a driver of the crawler vehicle arranged within the driver's cab, and a plurality of screens, each of which is arranged within the driver's cab and is configured to display a screenshot reproducing operational information. The crawler vehicle also comprises a control system, which is in communication with each screen and is configured to control the screenshot displayed by each screen and a user interface, which is in communication with the control system, is configured to receive commands from the driver of the crawler vehicle and to transmit the commands to the control system, and is arranged at such a distance from the seat so as to be controllable by the driver of the crawler vehicle while the driver is seated on the seat. In accordance with these embodiments, the driver of the crawler vehicle can display an amount of operational information appropriate to the relative complexity of the operational circumstances and can manage the screenshots displayed by each screen in a personalized manner while remaining seated in the seat, in the driving position. In other words, it is not necessary for the driver of the crawler vehicle to stand up from the seat to change the settings of one of the screens, which can be positioned in a position out of the driver's reach when the driver is seated.

In additional embodiments, the driver of the crawler vehicle can set the screenshots displayed from each screen based on their preferences and display the operational information they need at any time. In particular, the operational information comprises one or more of operational parameters of the crawler vehicle, information about the operations to be performed, information about characteristics of the environment surrounding the crawler vehicle, images captured outside the driver's cab and/or videos captured outside the driver's cab. In this way, it is possible to provide the driver of the crawler vehicle with all the operational information necessary to facilitate the tasks of the driver.

In certain embodiments, the control system is configured to control each screen so as to change the respective screenshot displayed, such as as a function of commands given by the driver of the crawler vehicle via the user interface. In this way, it is possible to set the configuration of the screenshots displayed by the plurality of screens based on the personal needs of each driver of the crawler vehicle.

In certain embodiments, each screen is arranged in the cab so as to maintain an unobstructed view of the driver of the crawler vehicle through a central portion of the windscreen while the driver is seated on the seat. In this way, it is possible to prevent the plurality of screens from obstructing the driver's view through the windscreen.

In certain embodiments, the crawler vehicle comprises at least one acquisition device, which is arranged outside the driver's cab, is in communication with the control system, and is configured to capture videos and/or images so as to provide the driver with a view outside the driver's cab. In more detail, the at least one acquisition device is facing in a direction substantially opposite to the travelling direction and is configured to capture video and/or images from an exterior lateral portion of the driver's cab; the plurality of screens comprising at least one rear-view screen configured to display the captured video and/or images. In other words, the rear-view screen is configured to show a view of the external environment similar to a view that the driver of the crawler vehicle would see through a rear-view mirror. In this way, the rear-view mirrors mounted outside the driver's cab can be replaced with rear-view screens arranged within the driver's cab. In practice, since the rear-view screen is arranged within the driver's cab, it is possible to improve the driver's rear and side visibility as the driver is not forced to look through the driver's cab windows, which can be relatively dirty or foggy and, consequently, can partially obstruct the driver's view outside the cab.

In certain embodiments, the at least one rear-view screen is arranged at a lateral portion of the windscreen. In this way, it is possible to avoid obstructing the driver's view of the crawler vehicle through a central portion of the windscreen.

### BRIEF DESCRIPTION OF THE DRAWINGS

Further characteristics and advantages of the present disclosure will become clear from the following description of a non-limiting example of embodiment thereof, with reference to the attached Figures, wherein:

FIG. 1 is a side view, with parts removed for clarity and schematised parts, of a crawler vehicle made in accordance with the present disclosure;

FIG. 2 is a perspective view, with parts removed for clarity and schematised parts, of a detail of the crawler vehicle in FIG. 1; and

FIG. 3 is a block diagram of a further detail of the crawler vehicle of FIG. 1.

### DETAILED DESCRIPTION

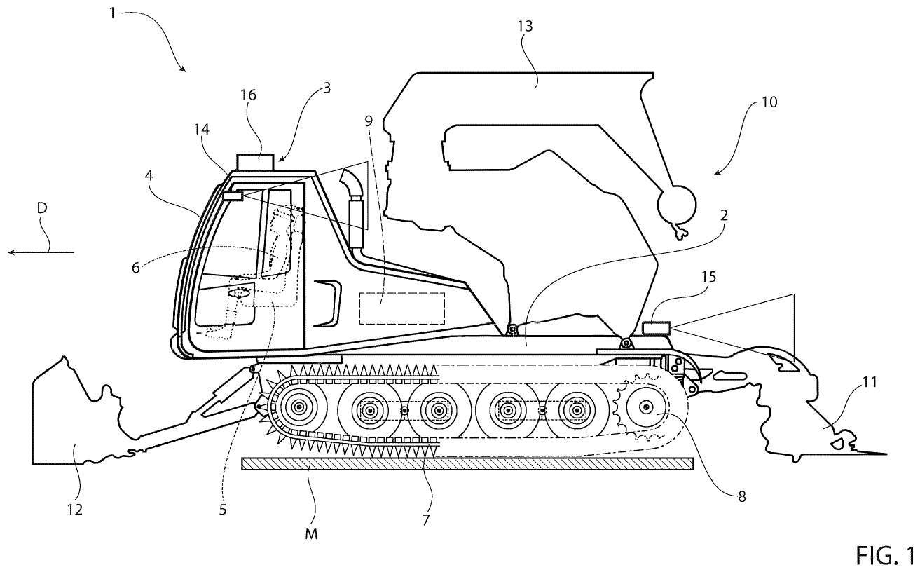

With reference to FIG. 1, 1 denotes as a whole a crawler vehicle, which in the case shown is used for the preparation of a snowpack M of ski runs. In certain embodiments, the crawler vehicle 1 is a snow groomer. In more detail, the crawler vehicle 1 of certain embodiments is used for the preparation of one or more of downhill ski runs, cross-country ski runs, ski-jumping ramps, half-pipe ski runs, snow-parks, and/or snowmobile tracks.

In accordance with a further embodiment, the crawler vehicle 1 can be used for the maintenance of sandy areas, such as beaches, or for agricultural operations, such as one or more of harvesting agricultural products, handling of agricultural products, forage silage, bagasse harvesting and/or bagasse handling.

In accordance with a further embodiment (not shown in the figures), the crawler vehicle 1 can comprise a shredder, such as a shredder positioned at the front of the crawler vehicle 1, that can be used for shredding vegetation.

In accordance with certain embodiments of the present disclosure, the crawler vehicle 1 is configured to advance in a travelling direction D and comprises a frame 2; a driver's cab 3, which is mounted on the frame 2 and comprises a windscreen 4; and a seat 5 for a driver 6 of the crawler vehicle 1 arranged within the driver's cab 3.

In certain embodiments, the crawler vehicle 1 comprises a pair of tracks 7 (only one of which is visible in FIG. 1); a pair of drive wheels 8 (only one of which is visible in FIG. 1), each of which is coupled to a respective track 7; a propulsion system 9 (e.g., an internal combustion or electric or hydrogen-powered) configured to transmit power to the drive wheels 8; and an assembly of accessory devices 10 connected to the frame 2.

In non-limiting embodiments of the present disclosure, the assembly of accessory devices 10 comprises a tiller 11, a shovel 12, and a winch 13. It is understood that the crawler vehicle 1 does not necessarily include all of the accessory devices 10 mentioned above. For example, the crawler vehicle 1 may comprise any one or two of the accessory devices 10 selected from the tiller 11, shovel 12 and winch 13.

In certain embodiments, the crawler vehicle 1 comprises at least one acquisition device 14, 15, which is arranged outside the driver's cab 3 and is configured to capture video and/or images. In particular, the crawler vehicle 1 comprises a pair of acquisition devices 14 (only one of which is visible in FIG. 1), each of which is facing in a direction substantially opposite to the travelling direction D and is configured to capture video and/or images from a respective exterior lateral portion of the driver's cab 3.

In practice of certain embodiments, the crawler vehicle 1 has no rear-view mirrors. Rather, each acquisition device 14 is configured to capture video and/or images corresponding to a view of the exterior of the driver's cab 3 that would be viewed by the driver 6 of the crawler vehicle 1 through a rear-view mirror, if any, while the driver 6 is seated on the seat 5.

In certain embodiments, the acquisition device 15 is facing in a direction substantially opposite to the travelling direction D and is configured to capture video and/or images from a respective rearward portion of the crawler vehicle 1.

In non-limiting embodiments of the present disclosure, the acquisition device 15 is mounted on a rear portion of the crawler vehicle 1, in a retracted position with respect to one or more of the direction of travel, the drive wheels 8 and/or the winch 13, and is configured to capture videos and/or images of a portion of the snowpack M, already processed in certain instances, to the rear of the tiller 11.

In accordance with certain embodiments of the present disclosure (not shown in the figures), the acquisition device 15 is attached to the tiller 11.

In accordance with an implementation form, each acquisition device 14, 15 comprises a 270° or 360° video camera.

In accordance with certain embodiments of the present disclosure, each acquisition device 14, 15 comprises a thermographic camera configured to acquire thermographic images and/or thermographic videos of the environment surrounding the crawler vehicle 1.

In certain embodiments, each acquisition device 14, 15 comprising a thermographic camera that enables one or more of the following to be detected: snow temperature(s); snow humidity; air temperature(s); air humidity; snowpack profile M (i.e., determined based on the temperature difference between snowpack M and air); distinguishing a worked surface of snowpack M from an unworked surface of snowpack M. The use of the thermographic camera is particularly useful in conditions of relatively poor visibility, such as at night or in foggy conditions.

In accordance with further embodiments of the present disclosure (not shown in the figures), each acquisition device 14, 15 may be mounted on the shovel 12 or winch 13 or along a ski run or on an aerial vehicle, unmanned in certain instances, such as an aerial drone.

In additional embodiments, the crawler vehicle 1 comprises a sensor assembly 16 configured to detect operational information comprising one or more of operational parameters of the crawler vehicle 1, information about the operations to be performed and/or information about the characteristics of the environment surrounding the crawler vehicle 1.

In accordance with certain embodiments (not shown in the figures), the sensor assembly 16 can be arranged on board additional crawler vehicles or on board an aerial vehicle, unmanned in certain instances, such as an aerial drone.

In certain embodiments, the sensor assembly 16 comprises one or more of a range sensor configured to detect a residual range of the crawler vehicle 1; a status sensor configured to detect a state of operation of the propulsion system 9 or the assembly of accessory devices 10; a recognition sensor configured to detect any obstacles around the crawler vehicle 1; and/or a lidar sensor configured to detect characteristics of the snowpack M.

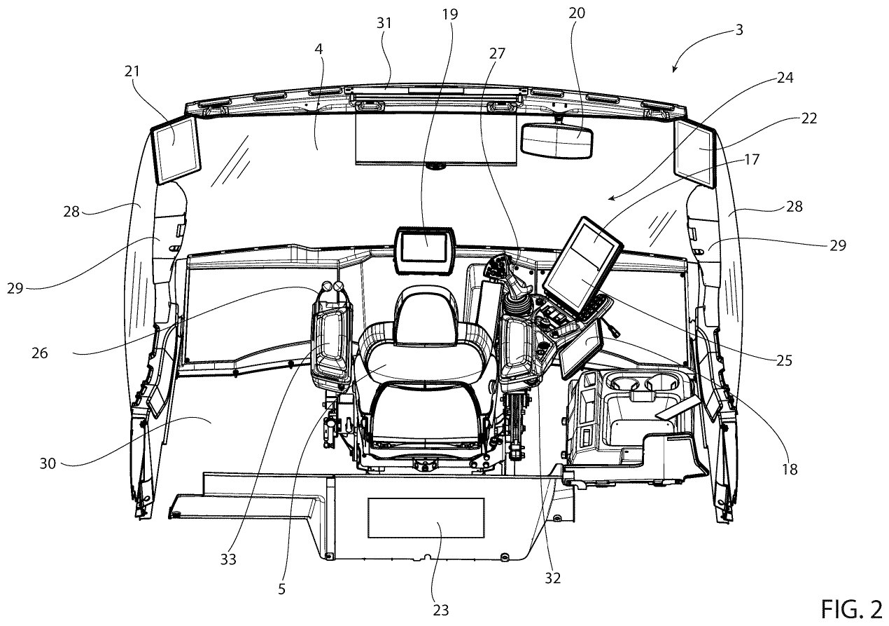

With reference to FIG. 2, the crawler vehicle 1 comprises a plurality of screens 17, 18, 19, 20, 21 and 22, each of which is arranged within the driver's cab 3 and is configured to display a screenshot reproducing the operational information. A control system 23 is in communication with each screen 17, 18, 19, 20, 21, 22 and is configured to control the screenshot displayed by each screen 17, 18, 19, 20, 21, 22. A user interface 24 is in communication with the control system 23, is configured to receive commands from the driver of the crawler vehicle 1 and to transmit the commands to the control system 23, and is arranged at such a distance from the seat 5 so as to be controllable by the driver of the crawler vehicle 1 while the driver is seated on the seat 5.

In various embodiments, the operational information comprises one or more of operational parameters of the crawler vehicle 1, information about the operations to be performed, information about characteristics of the environment surrounding the crawler vehicle 1, images captured outside the driver's cab 3 and/or videos captured outside the driver's cab 3. In more detail, each acquisition device 14, 15 is in communication with the control system 23, which is configured to control each acquisition device 14, 15 and to receive the images and/or videos captured outside the driver's cab 3 from each acquisition device 14, 15.

In certain embodiments, the sensor assembly 16 is in communication with the control system 23, which, in particular, is configured to control the sensor assembly 16 and to receive the operational information detected by the sensor assembly 16.

In the non-limiting embodiment of the present disclosure, the user interface 24 comprises a touch sensor 25, which is integrated into the screen 17 and is configured to detect a touch or a swipe on the screen 17. In addition, the user interface 24 comprises a control lever 26 and/or a joystick 27. In practice, the user interface 24 enables the driver to control the movement of the crawler vehicle 1 and the operation of accessory devices 10. In certain embodiments, the control lever 26 and joystick 27 are configured to drive the travelling movement of the crawler vehicle 1 and to control the movements of the accessory devices 10.

In certain embodiments, the seat 5 comprises a pair of armrests 32 and 33, to which the user interface 24 is coupled. In more detail, the joystick 27, the screen 18 and the screen 17 in which the user interface 24 is integrated are arranged on the armrest 32. The control lever 26 is arranged on the armrest 33.

In accordance with certain embodiments, the driver's cab 3 comprises two lateral windows 28; two lateral uprights 29, each of which is arranged between the windscreen 4 and the respective lateral window 28; a lower platform 30; and a roof 31. In particular, the seat 5 is mounted on the lower platform 30 in a central position of the driver's cab 3.

In accordance with certain embodiments (not shown in the figures), the driver's cab 3 comprises further seats for possible passengers of the crawler vehicle 1 arranged alongside the seat 5.

In certain embodiments, each screen 17, 18, 19, 20, 21, 22 is arranged in the driver's cab 3 so as to maintain an unobstructed view of the driver of the crawler vehicle 1 through a central portion of the windscreen 4 while the driver is seated on the seat 5. In more detail, the screens 19, 20, 21 and 22 are arranged at such a distance from the seat 5 as to be unreachable by the driver of the crawler vehicle 1 while the driver is seated on the seat 5. As illustrated, the screen 19 is arranged on the lower platform 30 in front of the seat 5 and the screen 20 is hung from the roof 31.

In certain embodiments, the screens 21 and 22 are rear-view screens configured to display the videos and/or images captured by the acquisition devices 14, 15. In more detail, each screen 21, 22 is arranged at a respective lateral portion of the windscreen 4, such as at respective lateral uprights 29.

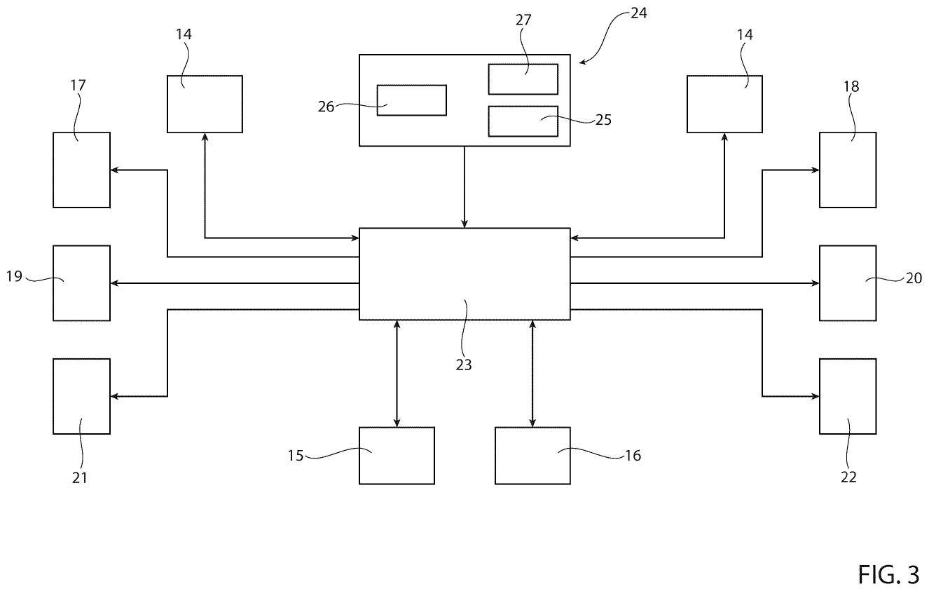

With reference to FIG. 3, the control system 23 of certain embodiments is configured to control each screen 17, 18, 19, 20, 21, 22 to change the respective screenshot displayed based on or as a function of the commands given by the driver of the crawler vehicle 1 via the user interface 24. By way of example, the control system 23 is configured to transfer a certain screenshot containing specific operational information from one screen 17, 18, 19, 20, 21, 22 to the other based on or as a function of the commands given by the driver of the crawler vehicle 1 via the user interface 24.

In use of certain embodiments, the user interface 24 receives commands from the driver of the crawler vehicle 1 and transmits the commands to the control system 23. At the same time, the acquisition devices 14, 15 transmit, in real time, the captured videos and/or images to the control system 23 and the sensor assembly 16 transmits further detected operational information to the control system 23. At this point, the control system 23 controls the screenshot displayed by each screen 17, 18, 19, 20, 21, 22 based on or as a function of the operational information received from the sensor assembly 16, based on or as a function of the videos and/or images captured by the acquisition devices 14 and 15, and based on or as a function of the commands given by the driver of the crawler vehicle 1 via the user interface 24. In this way, through the user interface 24, the driver of the crawler vehicle 1 can set their preferences regarding the display modes and the configuration of the screenshots displayed by each screen 17, 18, 19, 20, 21, 22 while remaining seated on the seat 5 in the driving position.

It is evident that variants can be made to the present disclosure without, however, departing from the scope of protection of the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

1. A crawler vehicle configured to advance in a travelling direction and comprising:
a frame;
a driver cab mounted on the frame and comprising a windscreen;
a seat arranged within the driver cab;
a plurality of screens arranged within the driver cab, each screen configured to display a screenshot reproducing operational information;
a control system in communication with each screen and configured to control the screenshot displayed by each screen; and
a user interface in communication with the control system and configured to receive a command from a driver and to transmit the command to the control system, wherein the user interface is arranged at a distance from the seat to be controllable by the driver while the driver is seated on the seat.

2. The crawler vehicle of claim 1, wherein the operational information comprises at least one of: an operational parameter of the crawler vehicle, information about an operation to be performed, information about a characteristic of an environment surrounding the crawler vehicle, an image captured outside the driver cab, and a video captured outside the driver cab.

3. The crawler vehicle of claim 1, wherein the control system is configured to control each screen to change the respective screenshot displayed based on the command received from the driver via the user interface.

4. The crawler vehicle of claim 1, wherein the user interface comprises a touch sensor integrated into at least one of the screens and configured to detect at least one of a touch and a swipe on that screen.

5. The crawler vehicle of claim 1, wherein the user interface comprises at least one of a control lever and a joystick.

6. The crawler vehicle of claim 1, wherein each screen is arranged in the driver cab to maintain an unobstructed view of the driver through a central portion of the windscreen while the driver is seated on the seat.

7. The crawler vehicle of claim 6, wherein at least one of the screens is arranged at a distance from the seat to be unreachable by the driver while the driver is seated on the seat.

8. The crawler vehicle of claim 1, further comprising an acquisition device arranged outside the driver cab, in communication with the control system and configured to capture at least one of a video and an image.

9. The crawler vehicle of claim 8, wherein:
the acquisition device is facing in a direction opposite to the travelling direction and is configured to capture the at least one of the video and the image from an exterior lateral portion of the driver cab; and
the plurality of screens comprise a rear-view screen configured to display the at least one of the video and the image.

10. The crawler vehicle of claim 9, wherein the rear-view screen is arranged at a lateral portion of the windscreen.

11. The crawler vehicle of claim 1, wherein the crawler vehicle is without any rear-view mirrors.
